(19) United States
(12) Patent Application Publication
(10) Pub. No.: US 2014/0282080 A1
(43) Pub. Date: Sep. 18, 2014

(54) METHODS AND SYSTEMS OF SHARING DIGITAL FILES

(71) Applicant: Carson GARNER, Great Falls, VA (US)

(72) Inventor: Carson GARNER, Great Falls, VA (US)

(21) Appl. No.: 13/831,584

(22) Filed: Mar. 15, 2013

(51) Int. Cl. G06F 17/30; H04L 12/58; H04L 29/06

(52) U.S. Cl. CPC G06F 17/30165; H04L 65/403; H04L 51/00
USPC 715/752; 715/753; 707/781

(57) ABSTRACT

Methods and systems for sharing digital information, such as photos, that include creating a viewable medium or website associated with an event using a computer interface. An identification module is provided at the website or other viewable medium that generates a unique event identifier that may be provided to or received by a plurality of individuals. Photos or other digital files or information relating to the event can then be communicated to the website or viewable medium by the individuals via user devices such that a subset of the information may be accessed at a remote computing interface e.g., by utilizing the event identifier.

### FIELD

Generally provided herein are methods and systems that may be used for compiling, filtering and/or sharing digital information, such as digital photographs and video files. More specifically, provided herein are methods and systems for sharing photos or other digital files directed toward one or more specific events utilizing a viewable medium, such as a website.

### BACKGROUND

As the world has become more connected as a result of communication devices that include cell phones, smartphones, tablets, and the like, information is constantly shared keeping individuals in touch with one another and enhancing the human experience. As a result, individuals more and more demand instant access to information and are in search of ways to utilize such technology to enhance their day-to-day lives.

Typically, at an event such as weddings, concerts, festivals, sporting events, photo shoots, and the like, individuals either video record the event with their Smartphone, digital camera, or the like, or take photos with the same to memorialize the event. At this time individuals often choose their best photographs and videos and email them to friends and family members or post them at social networking sites such as Facebook® or My Space®.

In other situations individuals will post video clips at websites such as YouTube, again, to memorialize an event and allow others to witness the event. Alternatively, websites exist that allow an individual to post a series of photos or pictures thereon and then send out a link to the website to their friends and family. These types of websites typically have some sort of password and encryption that is needed that once entered allows an individual to access the photographs of the individual.

Despite these advancements, problems still remain. In particular, often when going to events such as weddings, concerts, sporting events, and the like one can only access photographs of the event that they themselves take or from friends or family members. In instances where an individual's camera is not working properly, was forgotten, or when the pictures taken are blurry, if the individual does not know another person that was at the event that can share their photographs, photos from the event can be lost and the experience diminished for an individual. Further, while some events such as concerts or sporting events may provide a proper setting to post YouTube clips for sharing photographs or videos of an event, many events such as weddings, family gatherings, and the like do not share the same quality. In particular, often it is desired to restrict who can see certain photographs and in cases where a FACEBOOK page or webpage is dedicated to an event there is a desire to restrict who can present photos or materials on such a website or page. In particular, an individual that is not associated with the event can find it humorous to post inappropriate or improper photographs that are undesirable to be shared with others.

### SUMMARY

Thus, a principal object of the present invention is to provide methods of sharing digital information relating to an event, such as digital photos and other digital files that allow multiple parties, such as attendees of the event, to share and access the information.

Yet another object of the present invention is to provide methods of sharing digital photos and other digital information that put restrictions on information being shared by individuals.

These and other objects, features, and advantages will become apparent from the specification and claims.

In example embodiments, methods of sharing digital information, such as digital photos, are provided that include generating a viewable medium, such as a website, at a computing interface, that is associated with an event. An identification module is provided that generates an event identifier for the event. Individuals may then be presented with at least one event identifier so that they can send photos, videos or other digital files recorded during the event or relating to the event to the website. Alternatively, individuals may be permitted to submit information based on their location, e.g., within the event vicinity. The website's administrator or event organizer may then review and filter submitted digital information to determine which information will ultimately be made accessible to one or more users having the event identifier, via user devices.

In further example embodiments, systems are provided for sharing digital information that include a server coupled to a database; in which the database includes information regarding available digital information or files that have been submitted with respect to the event by remote users, or otherwise made available by remote users. The server may be adapted to control by using a computer, end user access to submitting and uploading digital information to the system relating to the event; the ability of an administrator to select and filter submitted digital information to be made available on the viewable medium; and end user access to viewing and purchasing selected and filtered information selected by the administrator related to the event. In particular, the server may be adapted to control which files are available for viewing by remote users relating to each event, such that only approved or authorized files (e.g., files that have been reviewed and approved or filtered by the event organizer, administrator or other authorized person) may be viewed by remote users.

Example embodiments also provide non-transitory machine or computer readable mediums and computer readable program products relating to the disclosed methods and systems.

The foregoing has outlined rather broadly the features and technical advantages of the present methods and systems in order that the detailed description that follows may be better understood. Additional features and advantages will be described herein, which form the subject of the claims. It should be appreciated by those skilled in the art that any conception and specific embodiment disclosed herein may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features, which are believed to be characteristic of the inventions, both as to their organization and methods of operation, together with further objects and advantages will be better understood from the following description when considered in connection with the accompanying figures. It is to be expressly understood, however, that any description, figure, example, etc. is provided for the purpose of illustration and description only and is by no means intended to define the limits the inventions.

### BRIEF DESCRIPTION OF THE DRAWINGS

Non-limiting example embodiments described herein, with reference to the following accompanying Figures.

FIG. 1 is a schematic diagram of a photo sharing system according to non-limiting example embodiments of the present methods and systems; and

FIG. 2 is a schematic diagram of a website of a photo sharing system according to non-limiting example embodiments of the present methods and systems.

### DETAILED DESCRIPTION

The aspects, advantages and/or other features of example embodiments of the present inventions will become apparent in view of the following detailed description, taken in conjunction with the accompanying drawings. In describing example embodiments, specific terminology is employed for the sake of clarity. However, the embodiments are not intended to be limited to this specific terminology. It should be apparent to those skilled in the art that the described embodiments of the present invention provided herein are merely exemplary and illustrative and not limiting. Numerous embodiments of modifications thereof are contemplated as falling within the scope of the present invention and equivalents thereto. It is to be understood that each specific element includes all technical equivalents that operate in a similar manner to accomplish a similar purpose.

Presented herein are various methods and systems of sharing digital photos and other digital information that allow individuals to share information relating to an event with other individuals at the event or invited to the event, with whom they may not necessarily have a connection within a social setting. This enhances the experience of the event and allows for additional sharing of information. Additionally, according to example embodiments, the event organizer can provide restrictions on who may submit and view the information and in addition restrict which information is posted to a website or other viewable medium, and with what restrictions, to ensure proper privacy is provided. In this regard, the present inventions meet all of the stated objectives.

Unless otherwise noted, technical terms are used according to conventional usage.

As used herein, “a” or “an” may mean one or more. As used herein, “another” may mean at least a second or more. Furthermore, unless otherwise required by context, singular terms include pluralities and plural terms include the singular.

The terms “digital information”, “files” and “digital files” as used herein are intended to include, but are not limited to any form of digital information or content now existing or that may later be developed, including, but not limited to photos, movies, video files, advertisements, audio, artwork, text or .pdf files (such as a reading, invitation, flyer, quote, literature, recipe, etc.), and the like, even if in compressed or encrypted formats.

According to certain embodiments, end users may each have at least one “device” or “user device” equipped with communications capability for uploading one or more files to a website associated with an event (or to a server hosting the website), and/or for viewing content on the website associated with an event. The “device” used for uploading one or more files may be the same device that was used for recording the digital file to be uploaded, such as a smartphone, or it may be e.g., a computer onto which digital files are transferred, for example from a camera or video camera. One or more of these actions may require certain software to be present on the device, and it may require that the user have one or more event identifiers associated with an event for which they either wish to upload a file and/or for which they wish to view files. The device may further have software or other capabilities for e.g., editing the one or more files prior to uploading the file (or after downloading a file from the website, which may be possible according to example embodiments—e.g., with permission or for a fee). Digital photo and video editing software is commonly available for many devices and is known in the art.

In some example embodiments, the user devices may include a browser providing the ability to browse and interact with sites on the Internet. In some other embodiments, the user devices may include software to communicate with the sharing system. In example embodiments, the software is a mobile application embedded in the user device.

The user device may be implemented as hardware having software installed thereon that implements the steps necessary to operate the sharing system according to example embodiments disclosed herein.

In the present application, the term “social network” is used to refer to any process or system that tracks and enables connections between members (including people, businesses, and other entities) or subsets of members. The connections and membership may be static or dynamic and the membership can include various subsets within a social network. For example, a person's social network might include members of their family. But the person may share an activity or event such as attendance at a reunion with only a subset of their family (e.g., their mom's side of the family).

An “event” may include for example, a conference, sporting event, or a leisure event such as a birthday party, school event, wedding, reunion, prom, etc. By way of further example, the “event” could be a photo shoot allowing individuals to present photograph material for magazines, publications, and the like. An “event” according to the present application may also include a virtual gallery, such as photographs, artwork, or other digital information by a particular photographer or artist.

Participants of an event may generate digital information or digital files such as photos, videos, audio, text, and so forth. The digital content may be generated by one or more user devices, such as personal mobile devices including one or more of cellular phones, smart phones, laptops, computers, digital cameras, and the like.

Provided herein are methods for compiling, filtering and/or sharing digital information, that includes creating or providing a viewable medium, such as a website, associated with an event, using a computer interface. The event website may have an event identifier associated therewith. The event identifier may be generated by an identification module provided at the viewable medium. Individuals may then be presented with at least one event identifier, allowing them to submit or communicate to the viewable medium via one or more user devices, digital information related to the event. That is, user devices may upload or email photos, videos or other digital files from the event to a website or event coordinator or administrator for consideration. Thus, methods further include allowing the individuals who have been provided with the event identifier to submit or communicate to the viewable medium via a user device digital information such as photos or videos related to the event. Alternatively, the presence of an individual or user device at a particular event (as may be determined e.g., by GPS or other positioning methods) may be sufficient as an event identifier to allow the individual to submit or communicate digital information related to the event. Example methods may further include displaying at least certain of the digital files to users at remote devices who have the event identifier. The methods may further include allowing an event organizer or other administrator to review or preview digital information that has been submitted and to select digital information and determine which set of selected, filtered digital information will be made available and/or accessible to users on a viewable medium (e.g., on a website), via user devices. Users or user devices may be required to have or input an event identifier associated with the event to have access to the selected filtered digital information.

It is contemplated that in example embodiments, different subsets of reviewed and filtered information may be made available to different users having a different event identifiers or codes relating to the same event. For example, at a sporting event, players may have access to different information than coaches, who may have access to different information than media, who may have access to different information than fans.

Example methods may further include permitting one or more user devices with access to selected digital information at a remote computing interface, using the event identifier. A computing interface may include for example, a keyboard, mouse, or touch screen).

Example methods may also include restricting access to the event identifier, such that only certain users or devices have access to the set of filtered information associated with the event. According to non-limiting examples, access to the event identifier is restricted based on predetermined calendar dates. According to other embodiments, access to the event identifier may be restricted based on a geographic location.

According to other embodiments, example methods include selecting digital photos that may be accessed at a remote location after the digital information is communicated from end users to a viewable medium, such as a website.

According to further embodiments, example embodiments may include setting a level of protection on the selected photos or information and/or on a selected album or group of photos or other information. Such a protection level may be set by virtue of having a default protection level, or it may be set by a user who submits the photo or by the administrator. The protection level set for certain files, or groups of files, may also be based e.g. on the type of event (such as an event having minors in attendance) or on the specific event (e.g., a wedding of a high profile person or couple).

In non-limiting examples, a location module may determine the location of the remote device used to send the digital files or information to restrict access to the event identifier. According to example embodiments, the event identifier may be selected from the group consisting of text string, barcode, quick code, Q-Code, and/or RFID ID.

The digital information may be communicated for consideration by the administrator or event organizer with respect to the event website, by an end user sending an email containing at least one digital file associated with the event, to e.g., an event coordinator or administrator or designated e-mail address. Alternatively, the end user may send a text with (or attaching) the information to a specific person or address. Or the end user may upload the information to a website. Alternatively, an end user may grant access by the administrator or organizer or a computing device of the administrator's to information on the end user's device. In such a context information data is maintained by the end user, but may be copied or transferred to the present system if selected by the administrator or event organizer. Communication of the information by the end user in this context may simply be communication of the location of the files or information, e.g., on a user device, rather than an actual transfer of the information by the end user.

Digital files submitted in accordance with the present methods and systems may be digitally tagged with one or more types of data relating to the digital file. In particular, digital files may be tagged with one or more types of data selected form the group consisting of, but not limited to, a person's name, a location, a recipe, a date, a relationship, an event name, a rating, and a document type.

That is, captured photos or videos (in other words, digital media content) may be tagged and associated with one or more social events on the user device or a remote server. The digital media content may also contain contextual information such as titles, time, date, conditions, location (e.g., GPS coordinates or city or site name), information related to recognized objects or individuals, and so forth.

The present methods may also include providing access to a file repository of filtered files relating to an event, via the Internet, by a user having the event identifier.

After approving particular files for inclusion in a group of files for on the website, the administrator or event organizer can create and/or modify various viewing and/or sharing rights so that end users having the event identifier code (e.g., attendees of the event) may view specific files and if desired, provide comments, apply tags or even download/copy and/or share (e.g., via social networking) one or more of the files for their own use. Sharing rights may vary by file depending e.g., on whether the file was taken by a professional photographer or videographer vs. being uploaded by another end user, whether copyright is claimed to the file/work, etc.

Non-limiting example embodiments also provide systems for sharing digital files that include a server coupled to a database, where the database may include information regarding digital information that has been submitted with respect to the event by remote users, such as with which events each file or piece of information is associated (e.g. matching the file with the event identifier), who submitted the file, which remote machine the file came from, the date of the file, and/or whether an administrator or event organizer has reviewed the file and selected it to be available for viewing on a website associated with an event.

According to example systems, the server may be adapted to monitor uploads and/or downloads from end users, and may be adapted to control uploads and/or downloads. The server may be adapted to control end user access to uploading and viewing and/or downloading files selected by an administrator related to the event, using a computer. In particular, the server may be adapted to control which files are available for viewing by remote users relating to each event, such that only approved or authorized files (e.g., files that have been reviewed and approved by the event organizer or other authorized person) may be viewed by remote users. Another way in which the server may control uploads, viewing and/or downloads of files may include for example, allowing only files that free of malicious files to be uploaded, viewed, or downloaded. Control may also be in the form of only allowing a certain number of uploads and/or downloads from a particular user (or a certain file size).

The server may include software capable of providing a digital fingerprint for each file, and/or software capable of scanning files for a digital imprint.

The overall systems may further include one or more end user devices as described above.

The server may include software capable of providing a digital fingerprint for each file. The server may further be capable of scanning files for a digital imprint. The server may also include software capable of monitoring for and/or detecting malicious files (including malicious software), such as viruses, cuckoo eggs, spyware, adware, pornography, spoof files, and the like.

Systems may further include other aspects to implement the methods discussed herein. Systems may include those in which at least a portion of the system or method is conducted within a secure website, for example in a case in which end users are able to purchase copies of files or products containing content from the files (e.g. photographic products) after viewing the file.

According to the present systems, a user having an event identifier associated with the event is granted the ability to search the database of digital files.

According to example embodiments, the system provides access to a file repository of filtered files relating to an event, via the Internet, by a user having and entering the event identifier.

According to example embodiments, the system provides a user having and entering the event identifier with the ability to search data or files, for example based on one or more digital tags associated with the filtered files. As used herein, the word “tag” refers to any type of digital data that can be assigned to a file to describe some aspect of that file through a tagging process. For images, the tagging may be for example, in EXIF format. For videos, documents and other file formats, any appropriate format may be used. The disclosed system allows users to create, view and share digital files.

The embodiments described herein can be implemented by various means, depending on the application. For example, the embodiments may be implemented in hardware, firmware, software, or in a combination thereof. For hardware implementation, the embodiments may be implemented with processors, controllers, micro-controllers, microprocessors, electronic devices, other electronic units designed to perform the functions described herein, or a combination thereof. Memory can be implemented within a processor or external to the processor. As used herein, the term “memory” refers to any type of long term, short term, volatile, nonvolatile, or other storage device and is not to be limited to any particular type of memory or number of memories, or type of media upon which memory is stored. For firmware and/or software implementation, the embodiments can be implemented with modules such as procedures, functions, and so on, that perform the functions described herein. Any machine-readable medium tangibly embodying instructions can be used in implementing the embodiments described herein.

Further provided are databases of digital files relating to an event, comprising one or more digital files such as photos or videos. Such databases may include those created by the present methods and/or systems.

Example embodiments also provide non-transitory machine or computer readable mediums and computer readable program products relating to the disclosed methods and systems. The non-transitory computer-readable medium may have instructions stored thereon, which when executed by one or more computers, cause the one or more computers to: receive digital information from one or more user devices associated with one or more users, wherein the users have submitted an event identifier such that the digital file may be associated with a particular event; associate the digital files with the event; allow an administrator to filter the digital information to determine which files will be made available to one or more users; and to facilitate access to the aggregated, selected and filtered digital information by one or more users having the event identifier.

A machine readable medium or computer readable program product may include a database of files produced by the present methods and systems. Other machine readable mediums may include software that allows one to create a webpage for an event and/or perform other steps of the methods and systems herein, such as reviewing uploaded files and selecting files that may be available for viewing on the webpage.

Incentives may be provided to encourage “uploading”. For example, end users who upload digital files such as photographs to the site may be provided with credit (e.g., the use of their name) associated with any files that are actually used by the event organizer and associated with the “event” on the website. Alternatively (or additionally), an end user may be permitted to download a certain number of files or have a credit toward any purchases, or a coupon code for use with any present or future purchases, in exchange for having shared his/her own files with the event. Various embodiments of such an incentive program are contemplated and may be used in accordance with non-limiting example embodiments.

A disk drive includes a computer-readable medium which stores one or more sets of instructions and data structures (e.g., instructions) embodying or utilized by any one or more of the methodologies or functions described herein. The instructions can also reside, completely or at least partially, within the main memory and/or within the processors during execution thereof by the computer system. The main memory and the processors also constitute machine-readable media.

The instructions can further be transmitted or received over the network via the network interface device utilizing any one of a number of well-known transfer protocols (e.g., Hyper Text Transfer Protocol (HTTP), CAN, Serial, and Modbus).

While the computer-readable medium is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java, Jini, C, C++, Pert, UNIX Shell, Visual Basic or Visual Basic Script, Virtual Reality Markup Language (VRML), ColdFusion or other compilers, assemblers, interpreters or other computer languages or platforms.

The computer-implemented method may further include obtaining contextual information related to the digital media content. The contextual information may include one or more of a tag, a time, a date, a geographical location, a comment, social event data, and information related to one or more individuals or objects presented in the content.

The computer-implemented method may further include further filtering parts of the digital files content based on one or more of contextual information, a user selection, a privacy instruction, and user personal information.

### EXAMPLES

### Example 1

### Wedding or Other Social Event

The Figures depict non-limiting example embodiments of photo sharing systems 10 that may be utilized by an event organizer 12. As shown in FIG. 1, example systems 10 may include a computing interface 14 that allows access to digital information 16 such as digital files to be viewed on a viewable medium 17.

The computing interface 14 can include but is not limited to computing devices, laptop computers, iPhones, Smartphones, Tablets, Blackberries, eReaders and the like that are able to convey or communicate digital information through software or mobile applications. Digital information 16 can include, but is not limited to uploadable files, downloadable files, streamed information, wireless information and the like.

The viewable medium can include, but is not limited to a website, webpage or portion thereof, mobile application, streamed video on a television or computing device or the like. The viewable medium 17 may present terms of service that must be accepted for use.

As depicted in FIG. 2, the system 10 additionally contains software 18 such as an identification module 20 that can generate an event identifier 22 for a specific event 24. According to example embodiments, the identification module 20 provides an access module 26 that can include a prompt box 28 appearing on the viewable medium, which may prompt an individual to enter e.g., a user ID, password and/or one or more event identifiers 22. While in certain embodiments the access module 26 may be a prompt box 28 that receives text, in other embodiments the event identifier 22 may be e.g., a barcode, quick code, Q code, RFID ID, or the like that can be scanned by a remote device or computer interface 32. Alternatively, the software 18 has a positioning application, such as a GPS application that can locate a remote device 32 that is conveying the digital information 16. If the remote device 32 is within a predetermined geographic region as a result of GPS coordinates, the GPS coordinates act as the event identifier 22 allowing an individual to send the digital information to the viewable medium 17 or to an administrator who may add the information to a set of information to be made available on the viewable medium. For example, if a user is taking photos at a wedding and chooses to submit photos from the wedding, while they are still present at the wedding, their presence at that geographic location at that time may be sufficient identifying information for the photos to be associated with the wedding event in the present systems without having to specifically enter an event identifier into a website or smartphone application.

Although the most common positioning technology is GPS, other positioning applications are contemplated within the scope of the present invention. As used herein, GPS—sometimes known as GNSS—is meant to include all of the current and future positioning systems that include satellites, such as the U.S. Navistar, GLONASS, Galileo, EGNOS, WAAS, MSAS, QZSS, etc. The accuracy of the positions, particularly of the participants, can be improved using known techniques, often called differential techniques. Differential techniques may include for example, WAAS (wide area), LAAS (local area), Carrier-Phase Enhancement (CPGPS), Space Based Augmentation Systems (SBAS); Wide Area GPS Enhancement (WAGE), or Relative Kinematic Positioning (RKP). Even without differential correction, numerous improvements are increasing GPS accuracy, such as the increase in the satellite constellation, multiple frequencies modeling and AGPS improvements, software receivers, and ground station improvements. Certain “events” might be held indoors, and indoor positioning systems that may be used may include e.g., IMEO, repeaters, Wi-Fi (Skyhook), Cell ID, pseudolites, RSS on any electromagnetic signal (e.g. TV) and other systems that are either now known or may be developed.

As an extra step, when e.g., digital photographs 34 are the digital information 16 received from individuals, the software 18 may also provide a setting for photos 34 received to be classified as copyrighted (with reserved rights), for creative comments, or rights free submission that is connected or associated with the photograph 34 and with the individual sending the photograph. Additionally, the software may allow tags or identifying information relating to a submitted photo or other information, to be added as set forth herein. Such user-added information or tags may be maintained with the information or file, or may be removed from the file for example by the administrator. For example, a user may submit a photograph with certain persons identified in the photo by way of tagging. If the persons are mis-identified or do not wish to be tagged, the photo may still be selected by the administrator, but the tag removed.

In operation, as an example, if one hundred people are invited to a wedding the wedding photographer as the event organizer 12 can create a managed collaborative gallery on the viewable medium 17 of digital information 16 including digital photos 34. The photographer can utilize the system 10 to present viewable mediums 17 including a unique website such as joneswed784@email.xyz and/or a live stream of photos 34 received presented on monitors at the wedding. The photographer or event organizer 12 can then pass out an invite to all the attendees of the wedding to submit their photos from the wedding 34 that were taken on their user devices 32 to the managed collaborative photo gallery presented on the viewable mediums 17. The invite provides an event identifier 22 in the form of text such as “joneswed784”, or it may be displayed somewhere for wedding guests to note, or it may be present for example on the wedding invitation or program. In this context, the photographer may act as the administrator in the present systems and methods. It is contemplated that a different administrator may review and/or filter files, such as an assistant, wedding coordinator, the wedding party themselves, etc. Additionally, it is contemplated that in certain contexts one or more persons may have administrative rights. Also, in the present context, it is contemplated, that the subset of information that may be displayed at the wedding itself as part of the “event”, while the event is still occurring, as photos are being submitted by users in real time, may be different (and possibly not as filtered) as the subset of information that is later made available after more information is submitted and reviewed by the administrator.

At this time the plurality of individuals or wedding attendees can use remote devices 32 such as their mobile phones, digital cameras, video cameras, etc. that can be linked to a computing interface, or the like to take photos or other digital information 34. Once the photos 34 (or other digital information such as video or audio files) are taken or recorded, an individual may then access the viewable medium 17 where a prompt box 28 appears and the event identifier 22 is entered. Then the individual electronically sends the photos 34 or other files or information that they wish to submit for possible placement on the viewable medium 17. As the individuals at the wedding begin sending or uploading their photos 34 or other files, the photographer or event organizer then selects desired photos 34 or other files to post for viewing. As set forth above, access to the viewable medium 17 may be restricted by the event organizer to e.g., only to individuals that were at the wedding or to individuals who were invited to the wedding, and received the event identifier 22, which may be in the form of the text identifier.

The present methods and systems allow other individuals at the event, such as a wedding, that are not necessarily friends or social acquaintances of individuals taking a particular photo, to access the viewable medium 17 and thus view photos 34 shared by other guests/attendees.

In addition, based on the restrictions that are able to be provided, the event organizer 12 can moderate poor and offensive photos 34 from being displayed on the viewable medium and copyright protection of photos 34 can also be placed on certain information by the event organizer 12 or photographer (whomever is acting as the administrator) to ensure e.g., that payment is made for photos 34 displayed by the photographer. In addition, people who were unable to attend the wedding could still access the photos 34 online using the event identifier 22.

### Example 2

### Music Concert

As another example, the event 24 may be a music concert in which e.g., 2000 people attend. The music concert organizer or event organizer 12 generates the event identifier 22 as the GPS location and date of the concert. Thus, only individuals physically attending the concert can send/submit photos or other digital information 34 relating to the event 24. The software 18 views the GPS data in the EXIF data or submitted by the photo-enabled mobile app or embedded in the photograph 34 communicated, emailed or uploaded via the remote device 32. The event organizer 12 then can moderate photos submitted by members and post them via a live stream on a viewable medium 17 such as a jumbotron or TV at the concert in real time allowing the crowd to interact and submit photos 34 to be viewed by the attendees.

As with other embodiments, attendees may be provided with an event identifier and may be permitted to later view digital information relating to the event. Additionally, certain of the information may be made available for downloading or purchase by the attendees.

### Example 3

### Sporting Events

By way of non-limiting example, as a sporting event is taking place, monitors (viewable medium) may be set up that are scrolling pictures and videos being taken by participants at the event and/or optionally professional photographers and videographers as well. These pictures and videos may be being reviewed quickly by an administrator before being added to the scroll for display.

After the event the viewable medium may be taken off-line or may contain only limited information, or may take a different form (while no longer on the monitors or Jumbo tron at the event, the information may be prepared for viewing on a website as the viewable medium), while further submission of information is being made. Additionally, further administrative review and filtering of the submitted digital information may made, prior to making the viewable medium available (e.g., for viewing and/or purchase of digital files or products containing such files) to event participants who submit the event identifier.

### Example 4

### Professional Artist/Photographer Galleries

In yet another embodiment the event 24 is a managed collaborative gallery where professional photographers can send their photographs 34 to be seen on a viewable medium 17 by any company, organization or individual desiring to purchase photographs 34. Once the viewable medium 17 is accessed, the professional photographer can set a level of copyright, creative comments, or rights free submission that is connected or associated with the photographs 34 sent such that the software 18 displays this information in association with the photographs 34 at the viewable medium 17. To that end, a photographer can be compensated for their photos 34.

For example, if a potential purchaser wants only photographs 34 of cowboys, professional photographers may submit their photos with the set of specific terms of service for the photos 34 and contact information to the viewable medium 17. Thus when the purchaser desires to select their photo 34, the photographer can be contacted and the photo can be used outside the scope of the viewable medium 17. The photographer or submitter of information may further tag the photos with e.g., keywords such as “cowboy” or with location information e.g., as to where the photograph was taken. Such a tag may also include a dynamic link to a location on for example a map website such as GOGGLE EARTH, MAPQUEST or GOGGLE MAPS.

In the context of such galleries, “events” may be organized by artist, type of work (e.g., water colors, prints of major cities), photographer, location (e.g., all photographs tagged as being taken at or near a particular location), etc. Thus, it is possible that the same digital information (e.g., photograph) may be included in more than one event. Alternatively, the work may only be in a single event, but a single event or group of events (e.g. group of artists) may have digital galleries, in which their works are searchable.

As can be seen, the event organizer 12 (or administrator) thus has complete control over the digital information 16. In particular, an event organizer 12 may review all digital information 16 such as photos 34 received before allowing them to be able to be accessed at the viewable medium 17 by other individuals. In this manner an event organizer 12 can discard duplicate, blurry, lewd, or other undesirable photographs 34 or information from being presented at the viewable medium 17.

In addition, the event organizer 12 can set restrictions on who can access the website 12. In particular, an event organizer 12 can allow any user with an event identifier 22 to view the photos or other information 34. Alternatively, the event organizer 12 can request an additional password to view photos 34. According to example embodiments, the event organizer 12 or the client (e.g., bride and groom) can be the only one that views the photos 34. Or alternatively, the submitter of the information (e.g., a professional photographer) may be the only one who has access to the information 34, and perhaps the submitter/photographer then provides an event identifier e.g., only to potential serious buyers of the photographs of his/her choosing.

In this manner if an individual hosting an event 24 such as a wedding, family reunion, or the like only wants certain individuals to have access to certain photos 34 or if the event organizer 12 is a wedding photographer that only allow certain photos to be seen or downloaded after a certain fee is paid, the website may be set up for such limited access or restriction.

It will be appreciated by those skilled in the art that other various modifications could be made to the device without departing from the spirit and scope of this invention. All such modifications and changes fall within the scope of the claims and are intended to be covered thereby.

What is claimed is:

1. A computer implemented method of sharing digital information, comprising:
creating a viewable medium associated with an event, using a computer interface;
providing an identification module at the viewable medium that generates an event identifier;
providing a plurality of individuals with the event identifier;
allowing individuals who have been provided with an event identifier to submit or communicate to the viewable medium via one or more user devices, digital information related to the event; and
allowing an administrator to select submitted digital information and to determine which set of selected, filtered digital information will ultimately be made accessible to users via user devices having the event identifier.

2. The method of claim 1, further comprising permitting one or more user devices with access to selected digital information at a remote computing interface, using the event identifier.

3. The method of claim 1, further comprising restricting access to the event identifier, such that only certain users or devices have access to the set of filtered information associated with the event.

4. The method of claim 3, wherein access to the event identifier is restricted based on predetermined calendar dates.

5. The method of claim 3, wherein access to the event identifier is restricted based on a geographic location.

6. The method of claim 1, further comprising selecting digital information that may be accessed at a remote location after the digital information are communicated from end users to the viewable medium.

7. The method of claim 1, further comprising setting a level of protection on the selected photos.

8. The method of claim 1, wherein a location module determines the location of the remote device used to send the digital information to restrict access to the event identifier.

9. The method of claim 1, wherein the event identifier is selected from a group consisting of text string, barcode, quick code, Q-Code, and RFID ID.

10. The method of claim 1, wherein the digital information is submitted or communicated by an end user by the user sending an email containing digital information associated with said event.

11. The method of claim 1, wherein submitted digital information has been digitally tagged with one or more types of data relating to the digital information.

12. The method of claim 11, wherein the digital information has been digitally tagged with one or more types of data selected form the group consisting of person's name, a location, a recipe, a date, a relationship, an event name, a rating, and a document type.

13. The method of claim 1, further comprising providing access to a file repository of selected, filtered digital information relating to an event, via the Internet, by a user having the event identifier.

14. The method of claim 1, wherein the user device comprises one or more of a digital camera, a video camera, a tablet device, a computer, a cellular phone, and a personal digital assistant (PDA).

15. The method of claim 1, wherein the viewable medium is selected from the group consisting of a website, webpage, or portion thereof.

16. A system for sharing digital information comprising
a server coupled to a database;
wherein said database comprises information regarding digital information associated with an event; and
wherein the server is adapted to control using a computer, end user access to submitting and uploading digital information to the system relating to the event, via at least one method selected from the end user having an event identifier and from the position of the end user device, which position may be determined by positioning software;
wherein the server is adapted to control using a computer the ability of an administrator to select and filter submitted digital information to be made available on the viewable medium; and
wherein the server is adapted to control using a computer end user access to viewing and purchasing selected and filtered information selected by the administrator related to said event.

17. The system of claim 16, wherein the server is adapted to control end user access by requiring that a user have an event identifier associated with the event.

18. The system of claim 17, wherein the system provides access to a file repository of selected, filtered information relating to an event, via the Internet, by a user having and inputting the event identifier.

19. The system of claim 16, wherein the system provides a user having and inputting the event identifier with the ability to view and search digital information relating to the event based on one or more digital tags associated with the selected and filtered information.

20. A non-transitory computer-readable medium having instructions stored thereon, which when executed by one or more computers, cause the one or more computers to:
receive digital information from one or more user devices associated with one or more users, wherein the users have submitted an event identifier or are present at a particular location such that the digital information may be associated with a particular event;
associate the digital information with the event;
allow an administrator to select and filter the digital information to determine which files will be made available to one or more users; and to
facilitate access to the aggregated selected and filtered digital information by one or more users having the event identifier.
